(19) United States
(12) Patent Application Publication
(10) Pub. No.: US 2015/0161860 A1
(43) Pub. Date: Jun. 11, 2015

(54) Security System and Associated Methods

(71) Applicants: Frank G. Pringle, Marlton, NJ (US); Lois E. Pringle, Marlton, NJ (US)

(72) Inventors: Frank G. Pringle, Marlton, NJ (US); Lois E. Pringle, Marlton, NJ (US)

(21) Appl. No.: 14/561,839

(22) Filed: Dec. 5, 2014

Related U.S. Application Data
(60) Provisional application No. 61/912,481, filed on Dec. 5, 2013.

(51) Int. Cl. G08B 13/196; H04N 7/18

(52) U.S. Cl. CPC G08B 13/19632; H04N 7/188

(57) ABSTRACT

A self-powered security system includes a mounting pole having a first end and a second end opposite the first end. The mounting pole is elongate along a longitudinal axis and defines a length between the first end and the second end. The self-powered security system also has a power generating subsystem mounted to the pole. The power generating subsystem includes a solar panel and a wind turbine. Additionally, the self-powered security system has a security subsystem mounted to the pole and powered by the power generating subsystem. The security subsystem includes at least one light and at least one camera. The self-powered security system also includes a control subsystem configured to control the at least one light and the at least one camera.

### CROSS-REFERENCE TO THE RELATED ART

This application claims priority from U.S. Provisional patent application Ser. No. 61/916,423, entitled “Security Systems and Associated Methods,” filed Dec. 5, 2013.

### TECHNICAL FIELD

The security system described herein may have applications in residential or commercial settings.

### BACKGROUND

Security systems are often considered critical in the protection of people and property in both residential and commercial settings. Such systems are often powered in conventional ways and typically require installation of electrical wiring. Additionally, power is required to run devices within these systems.

### SUMMARY

A self-powered security system includes a mounting pole having a first end and a second end opposite the first end. The mounting pole is elongate along a longitudinal axis and defines a length between the first end and the second end. The self-powered security system also has a power generating subsystem mounted to the pole. The power generating subsystem includes a solar panel and a wind turbine. Additionally, the self-powered security system has a security subsystem mounted to the pole and powered by the power generating subsystem. The security subsystem includes at least one light and at least one camera. The self-powered security system also includes a control subsystem configured to control the at least one light and the at least one camera.

A method of security monitoring includes generating power using at least one of a solar panel and a wind turbine. The method also includes powering at least one light and at least one camera using power created during the generating step. Additionally, the method includes controlling the at least one light and the at least one camera.

### BRIEF DESCRIPTION OF THE DRAWINGS

FIG. 1 is a perspective view of a security system;

FIG. 2 is a perspective view of a portion of the security system shown in FIG. 1;

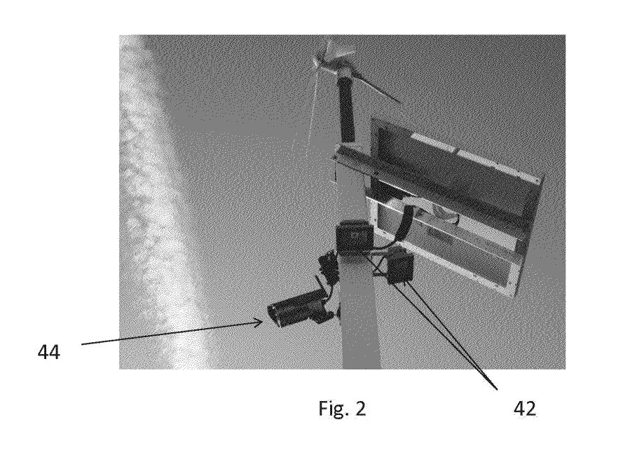

FIG. 3 is a schematic of the security system shown in FIGS. 1 and 2; and

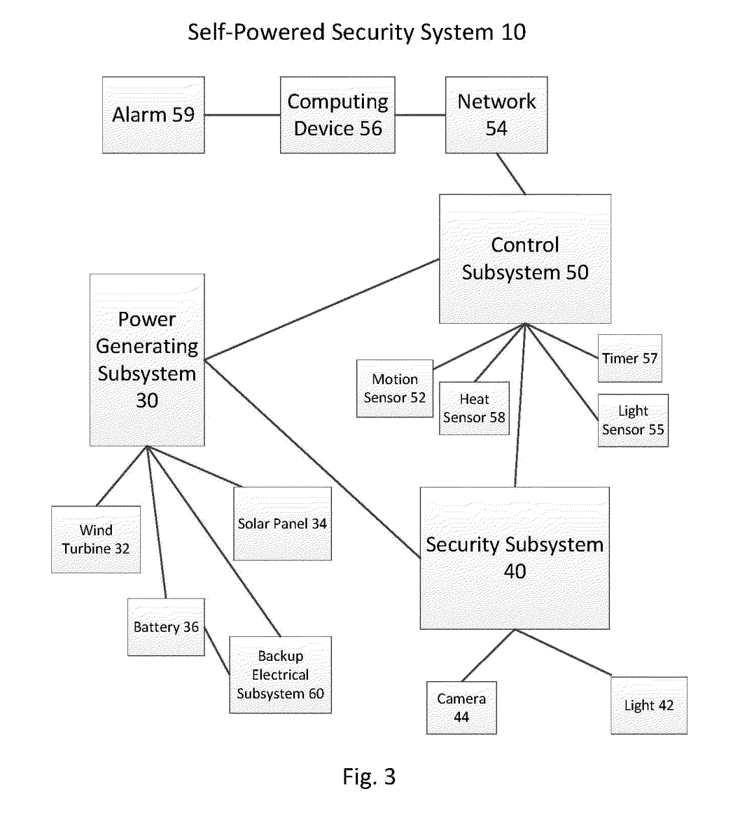

FIG. 4 is a schematic of the security system shown in FIGS. 1-3.

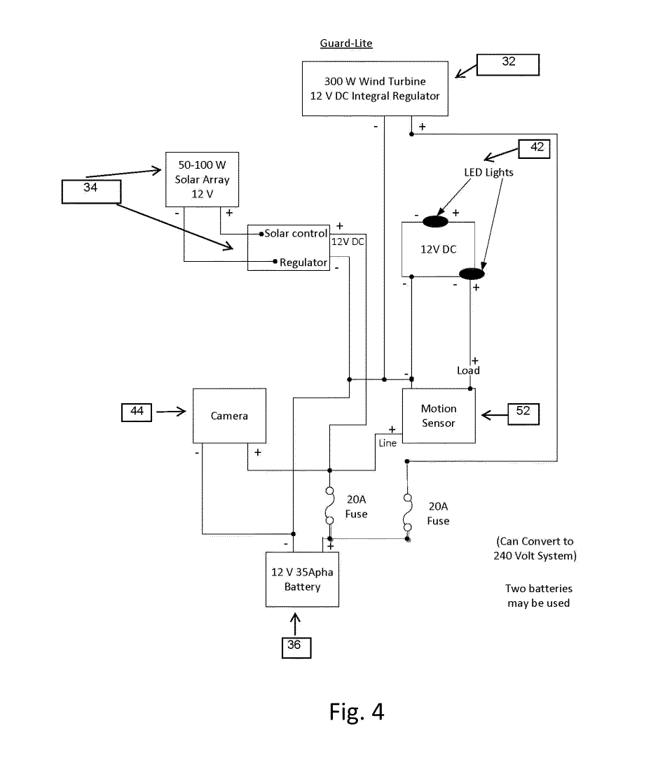

### DETAILED DESCRIPTION OF INVENTION

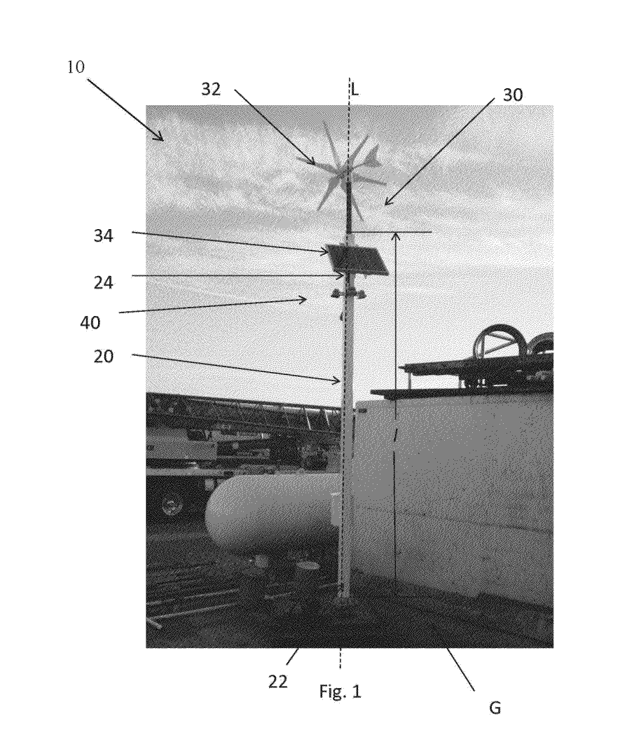

As illustrated in FIG. 1, a self-powered security system 10 includes a mounting pole 20, a power generating subsystem 30 mounted to the pole, a security subsystem 40 also mounted to the pole and powered by the power generating subsystem 30, and a control subsystem 50 configured to control the power generating subsystem 30 and the security subsystem 40.

Mounting pole 20 has a first end 22 and a second end 24 opposite the first end. The mounting pole 20 is elongate along a longitudinal axis L and defines a length l along the longitudinal axis between the first end 22 and the second end 24. In the embodiment shown, length l is approximately 14.5 feet, but length l may be varied so long as the power generating subsystem 30 and security subsystem 40 are at a sufficient height when self-powered security system 10 is assembled to function properly. For example, while not limiting, length l may range from 10-20 feet. In some embodiments, mounting pole 20 may be square in cross-section, such as having a 4 inch square cross-section. Alternatively, mounting pole 20 may be round or rectangular in cross-section.

Mounting pole 20 may be made of carbon steel covered by either a plastic sleeve or a powder coating. Alternatively, mounting pole 20 may be made of wood, such as that typically used on telephone poles. Mounting pole 20 may be secured so to as to extend perpendicular to a ground level G. Specifically, first end 22 of mounting pole 20 may be secured with bolts into a concrete foundation. Alternatively, first end 22 may be secured in a concrete-filed hole. Metal parts in self-powered security system 10, such as mounting pole 20 are bonded. The self-powered security system 10 is grounded. Bonding and grounding protect self-powered security system 10 from damage from lightening. Additionally, a ground rod (not shown) may be secured to mounting pole 20.

Power generating subsystem 30 includes a wind turbine 32 and a solar panel 34 that are attached to the second end 24 of the mounting pole 20. Wind turbine 32 may be a high efficiency 300 watt carbon fiber plastic turbine. Wind turbine 32 may include a long lasting permanent magnet direct drive. For example, wind turbine 32 may be a lightweight permanent magnet type wind generator such as P-300W Hyacinth model manufactured by Green Electric of China. Solar panel 34 may have a 100 watt output and may be capable of producing 4.5 kWh/day. For example, solar panel 34 may be a 100 Watt UL polycrystalline solar panel with built in diodes manufactured by Windy Nation in Ventura, CA.

Excess energy generated by the wind turbine 32 and solar panel 34 may be stored in a battery 36 for later use. Battery 36 may be a sealed lead acid type such as a gel cell. For example, battery 36 may be a Group U1 UB12350 from Universal Battery of Manchester, Va. In some embodiments, two batteries may be connected to the wind turbine 32 and solar panel 34. In some embodiments, battery 36 can store energy sufficient to run security subsystem 40 for up to 24 hours.

Security subsystem 40 includes at least one light 42 and at least one camera 44 that are each mounted on the second end 24 of the mounting pole 20. Lights 42 may be 6000° Kelvin lamps with 60,000 hours+lifetimes and have 900 lumens each. For example, lights 42 may include LED light, such as an LED 12v made by Yuelectron of China. Camera 44 may be configured to provide HD video visual with a 105° range. Camera 44 may also include infrared night vision or motion sensing technology. For example, camera 44 may be a 720P HD camera from Shenzhen Anbash Technology of China. Camera 44 may also include a sleep mode feature, where, if the motion sensing technology detects a period of inactivity, Camera 44 automatically shifts into an off-mode or into a mode that uses less power. Camera 44 will automatically shift out of sleep mode once the motion sensing technology detects activity again.

Self-powered security system 10 is configured to be controlled via control subsystem 50. Control subsystem 50 may be configured to be controlled by a computing device 56 that communicates with the installation (i.e., subsystems 30, 40 on mounting pole 20) via a network 54, such as a wireless or cellular network. Control subsystem 50 includes a user interface (not shown) on computing device 56 that functions to permit a user to control the self-powered security system 10 from a remote location and to send and retrieve data from the security subsystem.

Control subsystem 50 includes a motion sensor 52. Lights 42 may be controlled based on the motion sensor 52. Alternatively, lights 42 may be controlled by a light sensor 55 or a timer 57 based on expected darkness at a given time of day during a given time of year. Control subsystem 50 may be adjusted to override set timing. Control subsystem 40 may also include at least one motor (not shown) configured to actuate the lights 42, camera 44, or both. Control subsystem 50 may be configured to send motion activated alerts to computing device 56 when motion sensor 52 detects movement. If the motion activated alerts are not responded to within a set period of time, such as by the input of a password, an alarm 59 will be triggered. Alarm 59 may be a silent alarm or an auditory alarm. Control subsystem 50 may be configured to relay the alarm signals to the appropriate local authorities so that emergency personnel can respond to any security breaches. Alternatively, the Control subsystem 50 may control camera 44 to record an image or series of images when the motion sensor 52 detects movement. Control subsystem 40 may also send data capturing the image(s) via the network 54 to a computing device 56 that may be located remote from the self-powered security system 10.

Control subsystem 50 may also include a heat sensor 58. Heat sensor 58 detects increases in temperature near self-powered security system 10, which may indicate a fire. Control subsystem 50 is configured to relay this information to local authorities so that emergency personnel may be sent to the location of the self-powered security system 10. Heat sensor 58 may be separate from or part of camera 44. For example, heat sensor 58 may be part of an infrared camera.

Battery 36 may also be controlled by control subsystem 50. Specifically, control subsystem 50 may regulate charging of battery 36 to minimize or avoid overcharging or undercharging. A regulator (not shown) may be used to regulate solar panel voltage and light control. A regulator may also be used for the wind turbine that is integral in the unit or a separate.

Power generating subsystem 30 is configured to produce excess energy over the energy needs of the security subsystem 40. Specifically, the self-powered security system 10 is configured to use approximately 10% of its maximum rated wind and solar energy, providing excess energy of approximately 3.9 kWh/day. This excess energy may be diverted via control subsystem 50 to energy consuming fixtures proximate the self-powered security system 10, for example, landscape lights. Alternatively, excess energy may be transferred via control subsystem 50 into a power grid (e.g., sold into the power grid).

In addition to power generated by the power generating subsystem 30, self-powered security system 10 may optionally receive power from a backup electrical subsystem 60 that is hardwired to a power grid. Backup electrical subsystem 60 is controlled by control subsystem 50 to deliver power to battery 36 and ultimately the security subsystem 40.

The embodiments shown in the figures and described above illustrate aspects of the present invention. The present invention is not limited to the particular embodiments shown in the figures, but encompasses structures and methods broader than the disclosure and limited only by the claims. For example, self-powered security system 10 may or may not have a backup electrical subsystem 60.

What is claimed:

1. A self-powered security system comprising:
a mounting pole having a first end and a second end opposite the first end, the mounting pole being elongate along a longitudinal axis and defining a length between the first end and the second end;
a power generating subsystem mounted to the pole, the power generating subsystem comprising a solar panel and a wind turbine;
a security subsystem mounted to the pole and powered by the power generating subsystem, the security subsystem comprising at least one light and at least one camera; and
a control subsystem configured to control the at least one light and the at least one camera.

2. The self-powered security system of claim 1, wherein the at least one light includes an LED light.

3. The self-powered security system of claim 1, wherein the at least one camera includes infrared night vision, motion sensing technology, or both.

4. The self-powered security system of claim 1, wherein the at least one camera includes a sleep mode feature.

5. The self-powered security system of claim 1, wherein the control subsystem is configured to be controlled by a computing device.

6. The self-powered security system of claim 5, wherein the control subsystem provides motion activated alerts to the computing device.

7. The self-powered security system of claim 6, wherein if the motion activated alerts are not responded to within a set period of time, a silent or auditory alarm will be triggered.

8. The self-powered security system of claim 1, wherein the control subsystem comprises at least a heat sensor, motion sensor, light sensor, or timer.

9. The self-powered security system of claim 1, wherein the wind turbine comprises high efficiency carbon fiber plastic.

10. The self-powered security system of claim 1, wherein the wind turbine comprises a permanent magnet direct drive.

11. The self-powered security system of claim 1, wherein the solar panel comprises polycrystalline solar panels.

12. The self-powered security system of claim 1, further comprising a backup electrical subsystem configured to provide backup power to the self-powered security system.

13. A method of security monitoring comprising:
generating power using at least one of a solar panel and a wind turbine;
powering at least one light and at least one camera using power created during the generating step; and
controlling the at least one light and the at least one camera.

14. The method of security monitoring of claim 13, wherein the at least one camera includes infrared night vision, motion sensing technology, or both.

15. The method of security monitoring of claim 13, wherein the controlling step includes the at least one camera detecting a period of inactivity and going into sleep mode.

16. The method of security monitoring of claim 13, wherein the controlling step includes using at least a heat sensor, motion sensor, light sensor, or timer.

17. The method of security monitoring of claim 13, wherein the controlling step includes using a computing device.

18. The method of security monitoring of claim 17 further comprising a step of sending motion activated alerts to the computing device.

19. The method of security monitoring of claim 18, further comprising a step of triggering a silent or auditory alarm if the motion activated alerts are not responded to within a set period of time.

20. The method of security monitoring of claim 13, wherein the powering step also includes using power created by a backup electrical subsystem.
